(19) United States
(12) Patent Application Publication
(10) Pub. No.: US 2006/0144456 A1
(43) Pub. Date: Jul. 6, 2006

(54) UMBILICAL FOR OFFSHORE/REDUCTION OF HYDROCARBONS

(76) Inventors: Christopher Donnison, North Yorkshire (GB); Alan Dutton, Tyne & (GB)

Correspondence Address: OSTROLENK FABER GERB & SOFFEN, 1180 AVENUE OF THE AMERICAS, NEW YORK, NY, 100368403, US

(21) Appl. No.: 10/535,902

(22) PCT Filed: Oct. 28, 2003
(86) PCT No.: PCT/GB03/04620

§ 371 Date: Sep. 16, 2005

(30) Foreign Application Priority Data
Nov. 20, 2002 (GB) 0227062.7

(51) Int. Cl. F16L 11/00

(52) U.S. Cl. 138/121; 138/127; 138/135

(57) ABSTRACT

An umbilical for use in the offshore production of hydrocarbons comprising an assembly of functional elements wherein at least one functional element is a flexible hose which comprises an inner corrugated metallic tube covered by a thermoplastic sheath which thermoplastic sheath is covered by a reinforcement layer and an external cover sheath.

This invention relates to an umbilical for use in the offshore production of hydrocarbons.

In deep water subsea oil field operations, umbilicals are used to transport power, signals or data to and from a subsea installation. An umbilical comprises a group of one or more types of functional elements such as electrical cables, optical fibre cables, or hoses for fluid transportation of, for example, gas, water or chemical products such as methanol. These functional elements are assembled together in an helical or S/Z manner and over-sheathed and/or over-armoured for mechanical strength and ballast. It is desirable for a single umbilical to be able to contain as many functional elements as are required for a particular application, for example, as are required for a particular oil field where the umbilical is intended for use.

Typically the components used, for example, for fluid transportation, in umbilicals are either thermoplastic hoses or steel tubes. Steel tubes are used because they provide greater collapse resistance, higher response time and they can transport more aggressive fluids. Steel tubes are usually made of only one layer and their manufacture generally involves straightforward welding operation. Furthermore steel tube hoses have the added advantage that diffusion of gases does not occur through the steel tube.

The major drawback of steel tubes is that they are not very flexible and must be assembled in the umbilical in a helical manner. This limits the number of components that can be put into the umbilical to the number of components that the helical laying machine can manage in any one layer.

Thermoplastic hoses typically comprise a thermoplastic liner covered by one or more reinforcement layers with the outermost reinforcement layer being covered by a thermoplastic sheath. Thermoplastic hoses are more flexible than steel tubes and as a result these hoses can be assembled in the umbilical in a S/Z manner. This method enables a greater number of components to be assembled in the umbilical. However, one of the drawbacks of thermoplastic hoses is that they are permeable to fluids (liquid and/or gas) and this creates problems when the hose is to be used either for fluid transportation or for gas lift applications, i.e. for transporting fluid or gas under controlled pressure. Gas diffusion through the thermoplastic liner can lead to safety problems, for example, when methane is being transported through the hose. Furthermore permeation through the liner will increase as the temperature of the fluids, i.e. gases or liquids, being transported increases.

Typically, when an umbilical is laid in the sea it is flooded with sea water thus exposing the hoses within the umbilical to an external hydrostatic pressure. However, in use, the thermoplastic hose may collapse if there is a large enough pressure differential between the service pressure (the pressure inside the thermoplastic hose) and the hydrostatic pressure (the pressure outside the thermoplastic hose). To prevent collapse, thermoplastic hoses may be provided with an internal carcass. Carcass hoses comprise a metal carcass inside a thermoplastic liner and are, for example, used to transport gas or methanol. The metal carcass is typically formed from an interlocked S profile metal strip wound at short pitch. This type of hose is more flexible than a steel tube. However, it still suffers from the problems associated with fluid diffusion through the thermoplastic liner as the interlocked carcass is not a sealed barrier.

There is a need for an umbilical which can contain a greater number of functional elements and which does not suffer from the above problems.

The present invention provides an umbilical for use in the offshore production of hydrocarbons comprising an assembly of functional elements wherein at least one functional element is a flexible hose which comprises an inner corrugated metallic tube covered by a thermoplastic sheath which thermoplastic sheath is covered by a reinforcement layer and an external cover sheath.

It is believed that it is particularly advantageous to use hoses of this construction in umbilicals because the corrugations in the metallic tube impart the desired flexibility to the hose thus enabling the umbilical to be manufactured using an S/Z spiraling machine with the result that a greater number of functional components can be contained within the umbilical. Furthermore, the corrugated metallic tube prevents fluids, including gases, from permeating through the hose and hence removes problems associated with chemical compatibility of the fluids with the layers covering the corrugated tube and safety problems due to gas diffusion, for example, methane diffusion. It has also been found that higher operating temperatures are possible for some applications.

Embodiments of the invention will now be described, by way of example only, with reference to the drawings, in which:

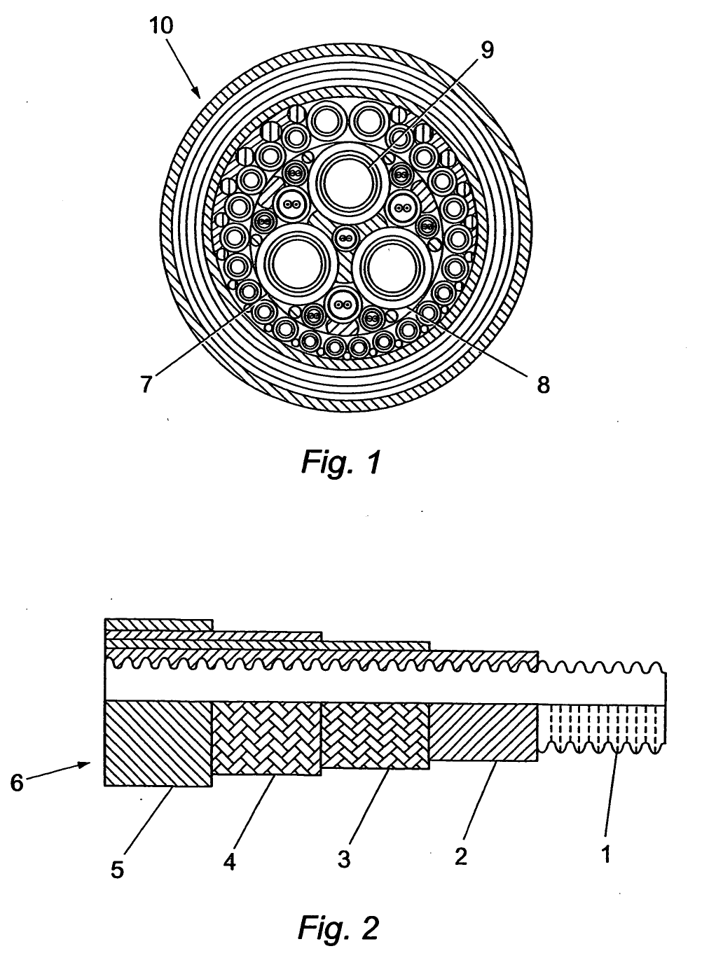

FIG. 1 shows a cross section of an umbilical according to the present invention.

FIG. 2 shows a part cross-sectional view of a hose for use in the umbilical according to the present invention and a part side-view of the hose showing the order of layering of the components forming the hose.

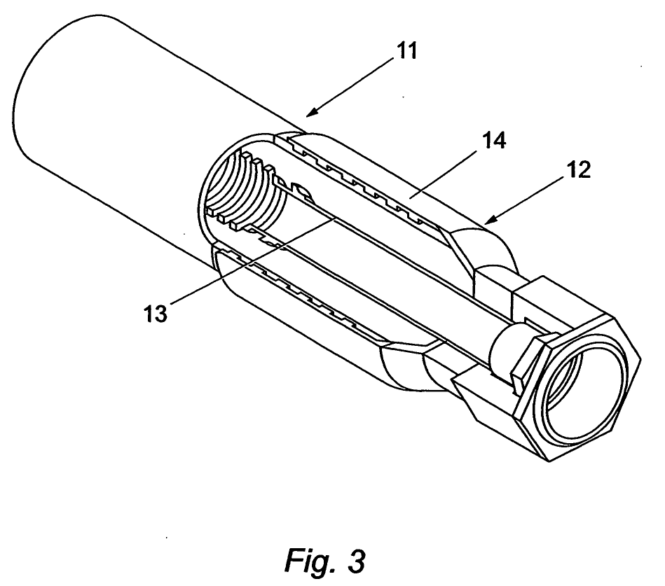

FIG. 3 shows a part cross-sectional view of a hose for use in the umbilical according to the present invention which hose comprises an end fitting comprising an insert and a flexible seal.

In FIG. 1, the cross-section of a typical gas lift and chemical injection umbilical (10) is shown. The umbilical contains three hoses (7,8,9) and many other functional components like fibre optic or electrical cables. In a preferred construction, the umbilical of the present invention comprises functional elements assembled in an S/Z manner. The functional elements of FIG. 1 are assembled in an S/Z manner and are over-sheathed and armoured to form the umbilical itself. However, umbilicals of other constructions, such as those formed using a helical process to assemble the functional elements, are also included in the present invention.

FIG. 2 shows a flexible hose (6) which is suitable for use in an umbilical (10) shown in FIG. 1. This flexible hose comprises a corrugated metallic tube (1), a thermoplastic sheath (2), a reinforcement layer (3,4) and an external thermoplastic sheath (5).

The corrugated metallic tube provides an impervious flexible barrier which prevents gas or liquid permeating from the inside of the hose through the hose construction. The profile of the corrugations can be changed to suit the final application of the hose. Preferably the corrugated tube has a nominal bore diameter 9.5 mm to 50.8 mm. The tube wall thickness can be between 0.1 mm to 1 mm depending on the requirements of the final application of the hose. The tube may be a continuous seam-welded corrugated flexible tube. The corrugated tube is preferably made of stainless steel, Monel 400, Inconel 625 or Super Duplex.

The thermoplastic sheath (or liner) which covers the corrugated tube acts to distribute the pressure from the corrugated tube uniformly to the reinforcement layer. Preferably, the inside diameter of the sheath follows the outside profile of the corrugated tube. Preferably, the outside diameter of the sheath is such that the sheath has a uniform surface for supporting the reinforcement layer. Preferably the sheath is cylindrical in shape, has a constant external diameter and is concentric with the corrugated tube. This allows uniform distribution of pressure from the inside of the corrugated tube to the reinforcement layer. The thermoplastic sheath allows transfer of hoop strain (radial loads) due to internal pressure to the reinforcement layer. The pressure distribution through the sheath prevents the corrugations collapsing and allows the flexible hose (6) to operate at much higher pressures than is possible without the sheath. The thermoplastic sheath can be made from any flexible thermoplastic material suitable for the operating temperature and pressure of the particular application. Preferably the material is chosen from HDPE, LDPE, Nylon 11, polyurethane, polyethylene, polyamide or polyvinyl chloride for normal operating temperatures. Operating temperatures of up to 200° C. are possible by using high temperature resistant polymers. In forming the sheath preferably the sheathing material is pressure-extruded in such a way as to extrude the material into the corrugations and leave a smooth concentric cover to provide a suitable surface to apply the reinforcement layer to. This extrusion process is less prone to failure than methods used to sheath interlock carcass hoses. The presence of sheathing material in the corrugations is important as this provides additional support which improves the dynamic capabilities of the hose as well as the behaviour of the product when pressurised.

The purpose of the reinforcement layer is to contain the pressure in the hose. Preferably, the reinforcement layer comprises at least one fibre or metallic wire layer. Preferably the fibre is a high tenacity fibre, for example, aramid fibre.

Preferably the fibre or wire is applied in the form of a braid. The application angle is chosen so as to provide minimum strain on the corrugated tube and to provide optimum load distribution between the corrugated tube and the fibre or wire layer. Angles of braid or wire application can range from 30° to 70° dependent on the application and the desired properties of the hose. By choosing the braid or wire angle to minimise stress in the corrugated tube and maximise the pressure load which can be taken by the hose, the hose can operate at a pressure above the maximum allowable pressure of the corrugated tube. The choice of fibre or wire will depend on the end application of the hose and the length of the hose. Preferably either Aramid fibre or stainless steel wire is used to form the high tenacity fibre or metallic wire layer.

The reinforcement layer may comprise more than one fibre or metallic wire layer. Additional fibre or metallic wire layers, for example, a second fibre layer (4), are added if the first layer is insufficient to contain the pressure within the hose.

The hose is provided with a thermoplastic cover sheath (5) which protects the reinforcement layers from external abrasion and in particular to protect the reinforcement layer under a hose end fitting. Preferably the thermoplastic cover is made from HDPE, polyamide 11 (Nylon 11) or polyurethane. The cover also enables identification to be applied to the hose. The thermoplastic cover (5) can be applied in such a manner that it prevents water ingress into the annulus defined between the two thermoplastic sheathes (2, 5). Hence it maintains a dry environment in the annulus where the reinforcement layers (3, 4) are located.

Preferably the hose is provided with an end fitting which comprises an insert and a flexible seal. A hose (11) with such an end fitting is shown in FIG. 3. The flexible seal (12) fits between the insert (13) and the corrugated tube (14). It is profiled to fit the internal corrugations of the corrugated tube. The seal thus provides support for the corrugated tube and ensures that the profile of the corrugated tube is maintained. The flexible seal also serves to ensure that pressure from the insert is distributed through the corrugated tube.

The flexible hose of the umbilical of the present invention is particularly suitable for the transport of fluids such as gas lift, liquids and highly permeable fluids, in the offshore production of hydrocarbons. The flexible hose is also suitable for use in other applications such as chemical injection.

1. An umbilical for use in the offshore production of hydrocarbons comprising an assembly of functional elements wherein
at least one of the functional elements is a flexible hose which comprises an inner corrugated metallic tube covered by a thermoplastic sheath which thermoplastic sheath is covered by a reinforcement layer and an external cover sheath.

2. An umbilical according to claim 1 wherein the assembly of functional elements are assembled in an S/Z manner.

3. An umbilical according to claim 1 wherein the thermoplastic sheath of the at least one flexible hose has an internal diameter which follows the external profile of the corrugated tube.

4. An umbilical according to claim 3 wherein the thermoplastic sheath of the at least one flexible hose has a constant external diameter.

5. An umbilical according to claim 4 wherein the thermoplastic sheath of the at least one flexible hose is concentric with the corrugated metallic tube.

6. An umbilical according to claim 1 wherein the thermoplastic sheath of the at least one flexible hose comprises HDPE, LDPE, Nylon 11, polyurethane, polyethylene, polyamide or polyvinylchloride.

7. An umbilical according to claim 1 wherein the reinforcement layer of the at least one flexible hose comprises at least one layer of fibre or metallic wire braid.

8. An umbilical according to claim 1 wherein the at least one flexible hose comprises an end fitting comprising an insert and a flexible seal wherein the flexible seal fits in between the insert and the corrugated tube and the flexible seal is profiled to fit internal corrugations of the corrugated tube.

9. An umbilical according to claim 1 wherein the external cover sheath of the at least one flexible hose is impervious to water.

10. An umbilical according to claim 1 wherein the thermoplastic sheath of the at least one flexible hose is adapted to distribute the pressure from the corrugated tube to the reinforcement layer to prevent collapse of corrugations of the corrugated tube.
